(19) United States
(12) Patent Application Publication
(10) Pub. No.: US 2022/0402780 A1
(43) Pub. Date: Dec. 22, 2022

(54) DEVICES AND METHODS RELATED TO SALT DISPLACEMENT FOR BRINE TANKS

(71) Applicant: IMPACT WATER PRODUCTS, Ontario, CA (US)

(72) Inventor: Edward Allan HORNER, Riverside, CA (US)

(21) Appl. No.: 17/846,028

(22) Filed: Jun. 22, 2022

Related U.S. Application Data
(60) Provisional application No. 63/213,298, filed on Jun. 22, 2021.

(51) Int. Cl. C02F 1/42

(52) U.S. Cl. CPC C02F 1/42; C02F 2303/16; C02F 2201/002

(57) ABSTRACT

In some embodiments, a device for use in a brine tank can include a shell that defines an interior volume and configured to displace granular salt from the interior volume when the granular salt is present in the brine tank. The shell can be further configured to allow liquid to pass therethrough while preventing the granular salt from entering the interior volume. In some embodiments, the shell can be mated with a tube such that during transfer of the liquid to and from the brine tank through an opening of the tube, the opening of the tube is positioned within the interior volume.

### CROSS-REFERENCE TO RELATED APPLICATION(S)

This application claims priority to U.S. Provisional Application No. 63/213,298 filed Jun. 22, 2021, entitled DEVICES AND METHODS RELATED TO SALT DISPLACEMENT FOR A BRINE TANK, the disclosure of which is hereby expressly incorporated by reference herein in its respective entirety.

### BACKGROUND

### Field

The present disclosure relates to devices and methods related to salt displacement for brine tanks in water treatment applications.

### Description of the Related Art

In many water treatment systems, an ion exchange process is utilized to reduce undesirable compounds and contaminants in water. Such an ion exchange process typically requires periodic recharging or regeneration of an ion exchange medium with a concentrated regenerant, commonly referred to as a brine solution. Such a concentrated brine solution is typically supplied from a brine tank.

### SUMMARY

In some implementations, the present disclosure relates to a device for use in a brine tank. The device includes a shell that defines an interior volume and configured to displace granular salt from the interior volume when the granular salt is present in the brine tank. The shell is further configured to allow liquid to pass therethrough while preventing the granular salt from entering the interior volume.

In some embodiments, the shell can be configured to mate with a tube such that when the tube is mated with the shell for operation including transfer of the liquid to and from the brine tank through an opening of the tube, the opening of the tube is positioned within the interior volume.

In some embodiments, the shell can have a shape that includes a wall, with at least a portion of the wall having a vertical component when the shell is positioned on a floor of the brine tank, and the floor of the brine tank defining a horizontal plane and the vertical component being in a direction perpendicular to the horizontal plane, such that the interior volume of the shell is defined by at least the wall. In some embodiments, the interior volume of the shell can be defined by the wall itself. In some embodiments, the wall can include a curvature such that the shell is a three-dimensional shell having a curved wall in a side sectional view. In some embodiments, the three-dimensional shell can have a partial or full ellipsoid shape. In some embodiments, the three-dimensional shell can have a truncated ellipsoid shape. In some embodiments, the three-dimensional shell can have a full ellipsoid shape such as an approximately spherical shape.

In some embodiments, the wall can include a straight portion such that the shell is a three-dimensional shell having a straight wall in a side sectional view. In some embodiments, the three-dimensional shell can have a cone shape having a base and a peak portion, with the base configured to engage the floor of the brine tank. In some embodiments, the base of the cone shape can have a circular shape.

In some embodiments, the three-dimensional shell can have a pyramid shape having a base and a peak portion, with the base configured to engage the floor of the brine tank. In some embodiments, the base of the pyramid shape can have a polygon shape having three or more sides.

In some embodiments, the interior volume of the shell can be defined by the wall and the floor of the brine tank. In some embodiments, the shell can be a three-dimensional shell having an open base configured to engage the floor of the brine tank to define the interior volume of the shell. In some embodiments, the wall can include a curvature such that the three-dimensional shell has a curved wall in a side sectional view. In some embodiments, the three-dimensional shell can have a partial ellipsoid shape such as a truncated ellipsoid shape.

In some embodiments, the wall can include a straight portion such that the shell is a three-dimensional shell having a straight wall in a side sectional view. In some embodiments, the three-dimensional shell can have a cone shape having an open base and a peak portion, with the open base configured to engage the floor of the brine tank. In some embodiments, the open base of the cone shape can have a circular shape.

In some embodiments, the three-dimensional shell can have a pyramid shape having an open base and a peak portion, with the open base configured to engage the floor of the brine tank. In some embodiments, the open base of the pyramid shape can have a polygon shape having three or more sides.

In some embodiments, the at least a portion of the wall can include a plurality of openings each dimensioned to allow flow of the liquid therethrough while preventing the granular salt from entering the interior volume. In some embodiments, each opening of the wall can be dimensioned to prevent passage of a salt particle having an average dimension greater than or equal to the dimension of the opening. In some embodiments, the dimension of the opening can be selected so that a partially dissolved salt particle or an undissolved salt particle having an average dimension that enters the interior volume of the shell is sufficiently small such that the salt particle either dissolves in the liquid or does not cause an undesirable effect when the liquid is transferred from the brine tank.

In some embodiments, the shell can be formed as a single piece. In some embodiments, the shell can be formed as an assembly of a plurality of pieces.

In some embodiments, the shell can be formed from one or more materials having resilience in a condition exposed to the granular salt and the liquid having dissolved salt. In some embodiments, the one or more materials of the shell can include plastic, metal, and/or alloy.

In some embodiments, the shell can further include a removable cap configured to allow the shell to maintain the interior volume substantially free of the granular salt when installed on the shell, and to allow access to the interior volume of the shell when removed from the shell.

In some implementations, the present disclosure relates to an assembly for use in a brine tank. The assembly includes a tube having an opening and configured to allow transfer of liquid to and from the brine tank through the opening. The assembly further includes a shell configured to be positioned within the brine tank and define an interior volume around the opening of the tube. The shell is further configured to displace granular salt from the interior volume when the granular salt is present in the brine tank. The shell is further configured to allow the liquid to pass therethrough while preventing the granular salt from entering the interior volume.

In some embodiments, the shell can be mated with the tube such that during transfer of the liquid to and from the brine tank through the opening of the tube, the opening of the tube is positioned within the interior volume.

In some implementations, the present disclosure relates to a brine tank system that includes a brine tank configured to store granular salt, an opening configured to allow transfer of liquid to and from the brine tank, and a shell that defines an interior volume around the opening. The shell is configured to displace granular salt from the interior volume when the granular salt is present in the brine tank. The shell is further configured to allow the liquid to pass therethrough while preventing the granular salt from entering the interior volume.

In some embodiments, the brine tank system can further include a tube having the opening, with the shell being mated with the shell such that during transfer of the liquid to and from the brine tank through the opening of the tube, the opening of the tube is positioned within the interior volume.

In some implementations, the present disclosure relates to a water treatment system that includes an ion exchange apparatus having an ion exchange medium configured to remove at least some of undesirable contaminants from water being treated. The system further includes a recharging apparatus coupled to the ion exchange apparatus and configured to provide a concentrated regenerant for the ion exchange medium. The recharging apparatus includes a brine tank configured to store granular salt, and a tube including an opening and configured to allow transfer of liquid to and from the brine tank through the opening. The recharging apparatus further includes a shell mated with the tube such that the shell defines an interior volume around the opening of the tube. The shell is configured to displace granular salt from the interior volume when the granular salt is present in the brine tank. The shell is further configured to allow the liquid to pass therethrough while preventing the granular salt from entering the interior volume.

In some implementations, the present disclosure relates to a kit for an existing brine tank. The kit includes a shell mated or capable of being mated with a tube such that when the tube is mated with the shell for operation including transfer of liquid to and from the brine tank through an opening of the tube, the shell defines an interior volume around the opening of the tube. The shell is configured to displace granular salt from the interior volume when the granular salt is present in the brine tank. The shell is further configured to allow the liquid to pass therethrough while preventing the granular salt from entering the interior volume. The kit further includes printed instructions for installing the shell within the brine tank.

In some embodiments, the kit can further include the tube. In some embodiments, the tube can be pre-mated with the tube.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1A shows a typical brine system that includes a resin tank and a brine tank.

FIG. 1B shows an example of the brine tank of FIG. 1A.

FIG. 2A shows an unassembled view of an assembly of a conventional grid plate and a support structure that can be utilized in the brine tank of FIG. 1B.

FIG. 2B shows an assembled view of the assembly of FIG. 2A.

FIG. 3 shows another example of a support structure configured to support a grid plate thereon.

FIGS. 4A and 4B show an example of how the conventional brine tank of FIGS. 1-3 can be operated to generate a concentrated brine solution.

FIG. 5A shows a perspective view of an example of a shell configured to displace granular salt when placed in a brine tank.

FIG. 5B shows a side sectional view of the shell of FIG. 5A when the shell is positioned on a surface such as a floor of a brine tank.

FIG. 6A shows an example of a shell, having a shape similar to the shell of FIGS. 5A and 5B, configured to mate with a tube to provide an interior volume about an opening of the tube, such that the interior volume is substantially free of granular salt when the shell is utilized in a brine tank.

FIG. 6B shows another example of a shell, having a shape similar to the shell of FIGS. 5A and 5B, configured to mate with a tube to provide an interior volume about an opening of the tube, such that the interior volume is substantially free of granular salt when the shell is utilized in a brine tank.

FIGS. 7A and 7B show operation of a brine tank with an assembly of a tube and a shell that is similar to the example assembly of FIG. 6B.

FIG. 8A shows a perspective view of another example of a shell configured to displace granular salt when placed in a brine tank.

FIG. 8B shows a side sectional view of the shell of FIG. 8A when the shell is positioned on a surface such as a floor of a brine tank.

FIG. 9A shows an example of a shell, having a shape similar to the shell of FIGS. 8A and 8B, configured to mate with a tube to provide an interior volume about an opening of the tube, such that the interior volume is substantially free of granular salt when the shell is utilized in a brine tank.

FIG. 9B shows another example of a shell, having a shape similar to the shell of FIGS. 8A and 8B, configured to mate with a tube to provide an interior volume about an opening of the tube, such that the interior volume is substantially free of granular salt when the shell is utilized in a brine tank.

FIG. 10A shows a perspective view of yet another example of a shell configured to displace granular salt when placed in a brine tank.

FIG. 10B shows a perspective and partially cutaway view of a brine tank having the example shell of FIG. 10A positioned therein.

FIG. 10C shows a plan view of the brine tank and the shell of FIG. 10B.

FIG. 11A show yet another example of a shell configured to displace granular salt when placed in a brine tank.

FIG. 11B show yet another example of a shell configured to displace granular salt when placed in a brine tank.

FIG. 12A shows an assembly where a plurality of shells are implemented inside a brine tank.

FIG. 12B shows that in some embodiments, a plurality of shells can be positioned at a plurality of different levels inside a brine tank.

FIG. 13 shows an assembly of a plurality of shells implemented within a brine tank similar to the example of FIG. 12B.

FIG. 14 shows a conventional grid plate positioned inside a brine tank so as to provide a substantially granular salt free region and a region occupied by granular salt.

FIG. 15 that shows a shell having an open side, such as the cone shaped example of FIGS. 5 to 7 and the pyramid shaped example of FIG. 10, positioned on a floor of a brine tank so as to define an interior volume that is substantially free of granular salt that is displaced and kept in an exterior region.

FIG. 16 shows a shell having a spherical shape similar to the examples of FIGS. 8, 9, 12 and 13, where the shell defines an interior volume that is substantially free of granular salt that is displaced and kept in an exterior region.

### DETAILED DESCRIPTION OF SOME EMBODIMENTS

The headings provided herein, if any, are for convenience only and do not necessarily affect the scope or meaning of the claimed invention.

The present disclosure relates to devices, systems and methods for displacing and/or elevating salt granules or pellets from and/or above a portion of a concentrated brine solution in a brine tank. By way of an example, a device having one or more features as described herein can be implemented as a part of a water softening system. Although various examples are described herein in the context of such a water softening system, it will be understood that one or more features of the present disclosure can be utilized in other devices and/or systems.

It is noted that ion exchange water treatment systems used for the reduction of hardness, tannins, nitrate, uranium and other contaminants typically operate by substitution of contaminants through an ion exchange process. Such ion exchange water treatment systems typically require periodic recharging or regeneration of an ion exchange medium with a concentrated regenerant, commonly referred to as a brine solution. The concentrated brine solution is usually supplied from a brine tank which may be an integral part of the water treatment system, or a separate tank.

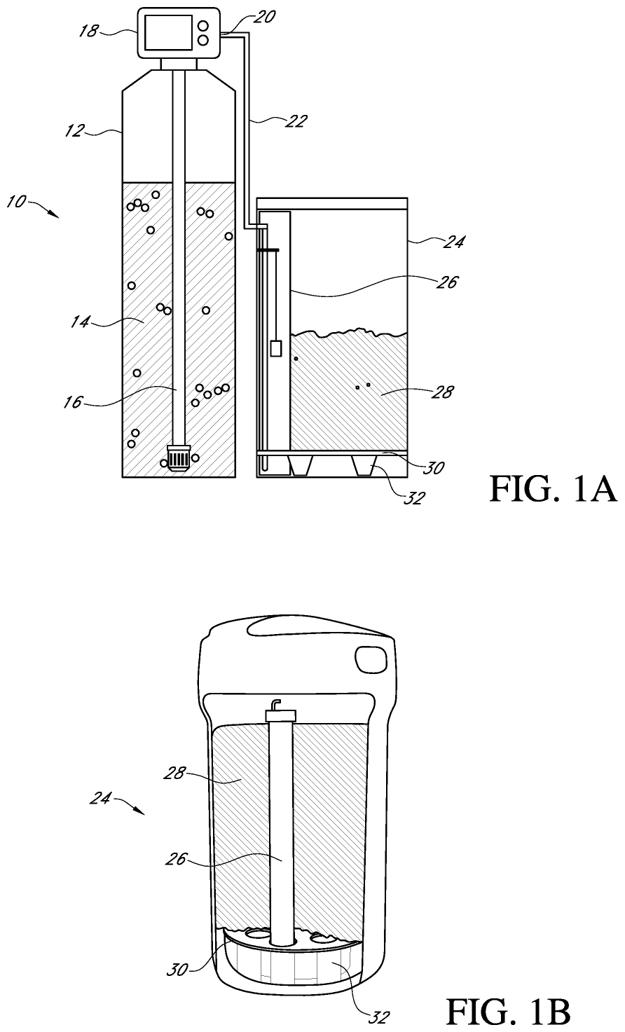

Referring to FIGS. 1A and 1B, a brine system 10 typically includes a resin tank 12 and a brine tank 24 interconnected through a fill tube 22. The resin tank 12 can include a volume of resin 14 and a riser tube with basket 16 to support a water treatment process such as an ion exchange process.

The brine tank 24 can include a volume of salt 28 supported on a grid plate 30 which is positioned above the bottom floor of the brine tank 24 by a grid plate support structure 32. When periodic recharging or regeneration of an ion exchange medium with a concentrated regenerant is desired, solution can be transferred from the resin tank 12 through the head valve 18 and the fill tube 22 to fill the brine tank 24 to a level determined by a float assembly 26. Some of the volume of salt 28 can dissolve in the introduced solution, and such a concentrated regenerant (e.g., a brine solution or simply brine) is typically drawn back to the resin tank 12 through the fill tube 22, a brine injector assembly 20 and the head valve 18.

It is noted that since the brine has a density greater than water, the brine is drawn from the bottom of the tank. Accordingly, a brine tank typically includes a salt bed (28 in FIGS. 1A and 1B), at least a portion of which is in contact with water, causing the salt (e.g., granular salt) to dissolve thereby forming the concentrated brine solution. It is common to utilize an apparatus such as the grid plate 30 and grid plate support 32 of FIGS. 1A and 1B to displace the granular salt 28 at a fixed level above the bottom floor of the brine tank 24, but below the top level of the brine solution in the brine tank 24. Salt is thereby dissolved into the water yielding the concentrated brine solution without any appreciable amount of undissolved salt being transmitted with the concentrated brine solution when the brine solution is drawn from the bottom of the brine tank 24 and transferred to the resin tank 12 through the brine valve 18.

It is further noted that brine tanks are typically constructed to accommodate a large volume of salt such that the corresponding water softening system may go through many regeneration cycles without having to continually replenish salt in the brine tank. A traditional salt grid plate, such as the example grid plate 30 of FIGS. 1A and 1B, which typically lies close to the bottom of the brine tank 24 are typically difficult to install and/or remove. Such a salt grid plate is also difficult to clean (e.g., under the grid plate) without removing the salt and the grid plate.

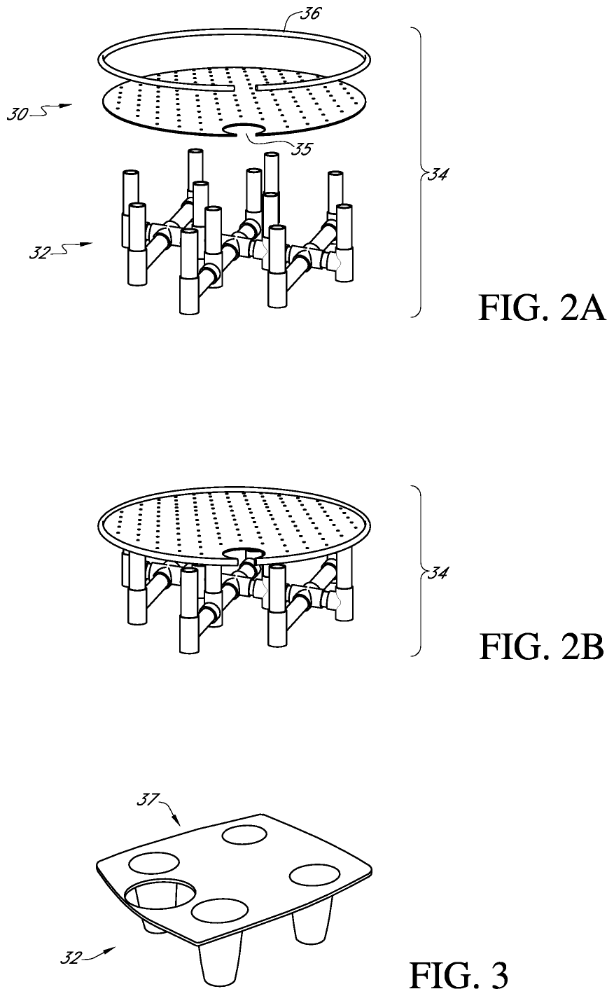

FIGS. 2A and 2B show an example of an assembly 34 that includes a conventional grid plate 30 and a support structure 32 dimensioned to provide support for the grid plate 30 and provide a volume at the bottom of a corresponding brine tank where granular salt is substantially excluded. The grid plate 30 is shown to include a plurality of openings dimensioned to allow brine solution to pass through while preventing granular salt from passing through (e.g., from the region above the grid plate 30 to the region below the grid plate 30).

As shown in the exploded view in FIG. 2A, a sealing ring 36 is shown to be provided at the perimeter of the grid plate 30. The lateral dimension of the grid plate 30 and the sealing ring 36 can be selected to prevent granular salt from passing through the edge portion of the grid plate 30. Similarly, an opening 35 provided through a portion of the grid plate 30 to accommodate a float assembly (26 in FIGS. 1A and 1B) can be dimensioned to allow the float assembly to fit therethrough, but prevent granular salt from passing through the opening 35.

A number of observations can be made for the conventional grid plate 30 and the support structure 32 of FIGS. 2A and 2B. For example, and as described above, the grid plate 30 and the sealing ring 36 need to be dimensioned to be relatively tight against the inner wall of the brine tank (24 in FIGS. 1A and 1B) to prevent granular salt from passing through the edge of the grid plate 30. Similarly, the opening 35 also needs to be dimensioned such that the float assembly (26 in FIGS. 1A and 1B) fits relatively tightly to prevent granular salt from passing through any gap between the float assembly and the perimeter of the opening 35. Either or both of such relatively tight fits, as well as the location of the grid plate 30 near the bottom of the brine tank, result in difficulty in installation and/or removal of the grid plate 30 (e.g., for initial installation, for servicing such as cleaning, etc.)

In another example, it is noted that in the brine tank 24 and the corresponding grid plate 30 of FIGS. 1 and 2, the flat design of the grid plate 30 spanning substantially the entire cross-sectional area of the brine tank 24 results in the grid plate 30 and the support structure 32 having to support substantially the entire weight of the granular salt volume. Accordingly, the grid plate 30 and the support structure 32 need to be designed to provide considerable strength and cross support capability to prevent a failure of the grid plate and/or the support structure 32. Thus, such a support structure can be implemented to include multiple pieces assembled in a complex manner, be implemented as a complex molded structure, etc.

In the example of FIGS. 2A and 2B, the grid plate 30 is shown to have a circular perimeter to accommodate a brine tank having a circular cross-sectional shape. It will be understood that a brine tank can have a cross-sectional shape other than a circular shape.

For example, FIG. 3 shows a support structure 32 configured to support a grid plate thereon. Such a grid plate can have a non-circular perimeter shape (e.g., approximately rectangular shape with rounded corners) similar to the perimeter 37 of the support structure 32.

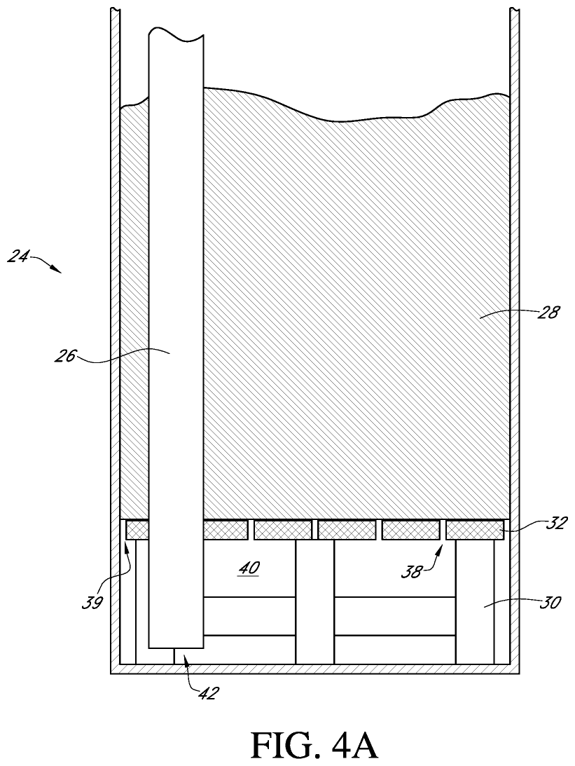

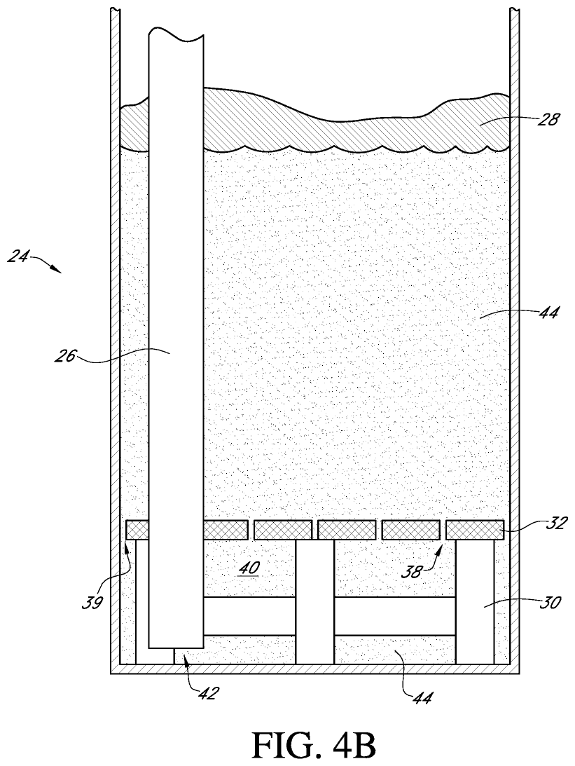

FIGS. 4A and 4B show an example of how the conventional brine tank 24 of FIGS. 1-3 can be operated to generate a concentrated brine solution. In FIG. 4A, the brine tank 24 is shown to be filled with a volume of dry granular salt 28. Such dry granular salt is shown to be supported by the grid plate 32, and the grid plate 32 is shown to be configured with a plurality of holes 38 that are dimensioned to allow passage of liquid therethrough but keep the granular salt 28 from passing through the grid plate 32. It is also noted that the grid plate 32 can be dimensioned so that a gap 39, if any, between the edge of the grid plate 32 and the inner wall of the brine tank 24 is sufficiently small to prevent the granular salt 28 from passing through the gap 39. Similarly, if there is a gap between an opening in the grid plate 32 and the float assembly 26, such a gap can be made to be sufficiently small to prevent passage of granular salt.

Configured in the foregoing manner, the grid plate 32 provides a volume 40 between the grid plate 32 and the floor of the brine tank 24, and the volume 40 can be free of any significant amount of undissolved salt. In FIG. 4A, the float assembly 26 is shown to include an opening 42 near the floor of the brine tank 24 to allow water to be introduced into the brine tank 24 and to allow a brine solution to be drawn from the brine tank 24.

In FIG. 4B, the brine tank 24 is shown to be filled with a volume of water 44 introduced through the opening 42 of the float assembly 26. Such water can be filled to a level that is preferably lower than the level of the granular salt 28. The water 44 can remain in the brine tank for a duration of time to achieve a desired salinity concentration of the brined water 44. Upon reaching such a desired concentration, the brine solution (44) can be drawn through the opening 42 and be transferred back to a resin tank (12 in FIG. 1A).

Disclosed herein are various examples of a device that can be utilized in a brine tank to provide one or more desirable functionalities. In some embodiments, such a device can include a shell having a shape and configured to mate with a tube such that when the tube is mated with the shell for operation including transfer of liquid to and from the brine tank through an opening of the tube, the shell defines an interior volume around the opening of the tube. The shell can be further configured to displace granular salt by a volume defined by the shape of the shell when the granular salt is present in the brine tank. The shell can be further configured to allow the liquid to pass therethrough while preventing the granular salt from entering the interior volume.

In the foregoing operating configuration, the tube can be, for example, a tube with a float assembly, and the opening of the tube can be an end of the tube positioned close to the bottom floor of the brine tank. The liquid can be a solution introduced to the brine tank to be provided with a higher concentration of dissolved salt, or such higher concentration salt solution to be drawn from the brine tank.

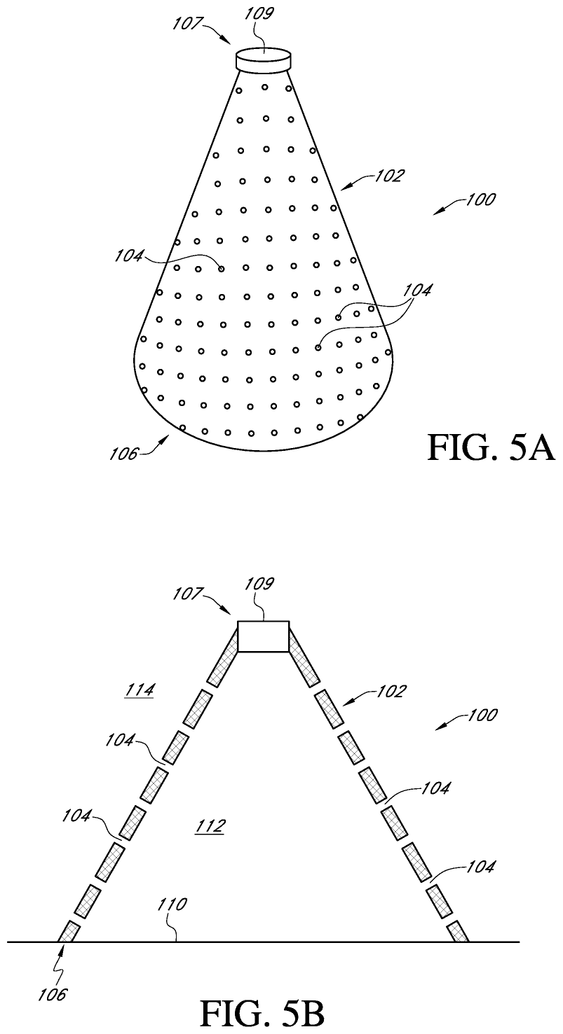

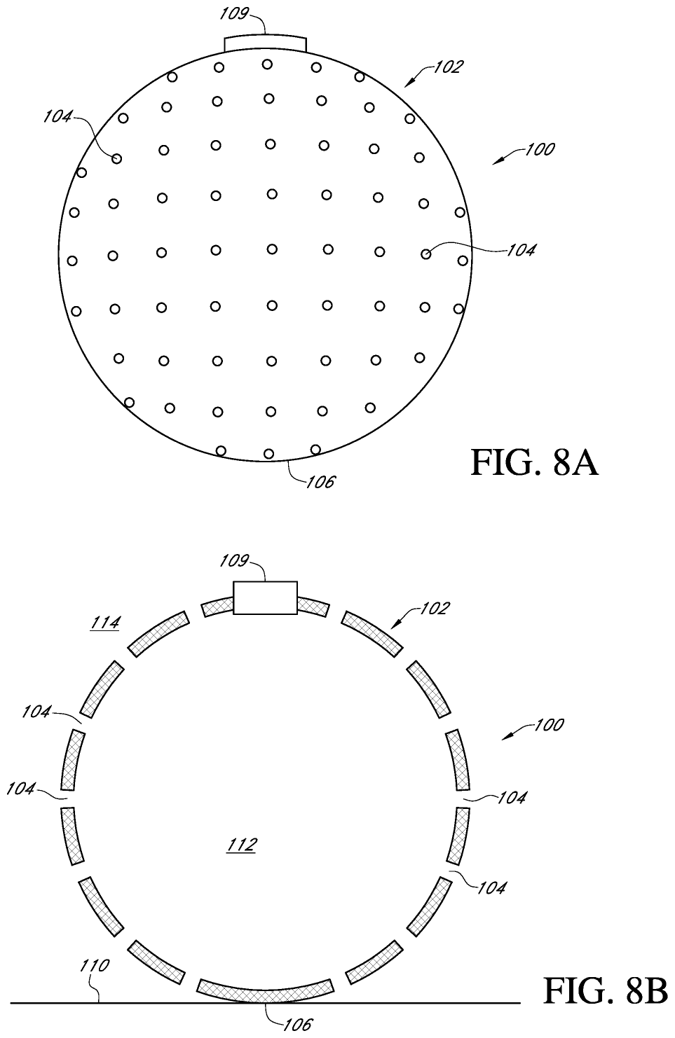

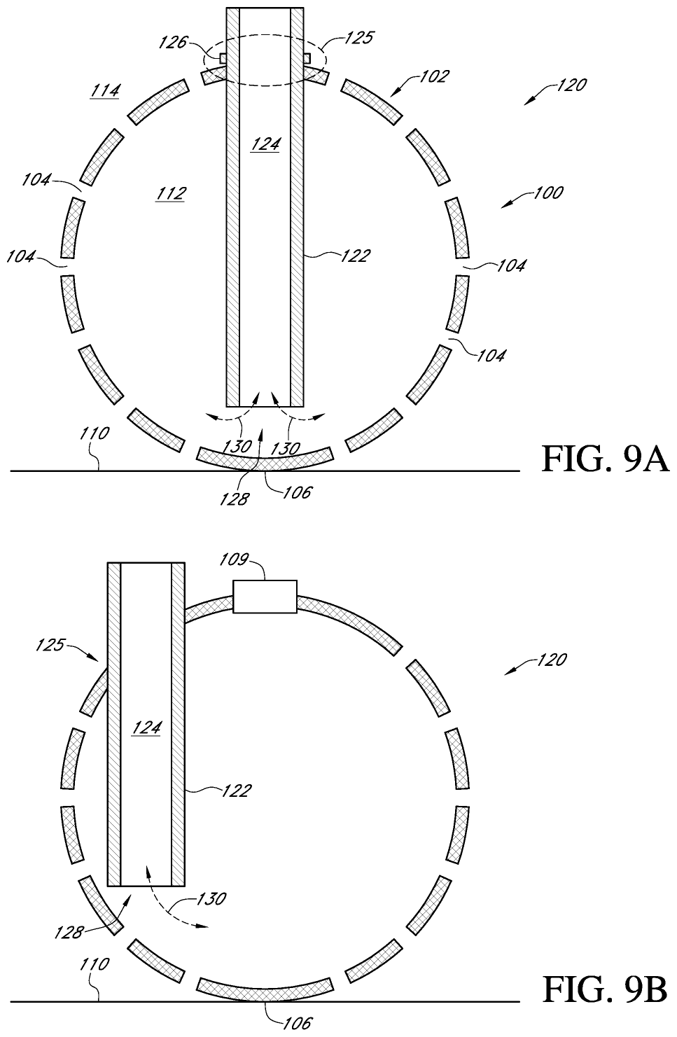

In some embodiments, a shell having one or more features as described herein can define an interior volume and include one or more surfaces where at least some of such surface(s) can include a plurality of openings dimensioned to allow liquid to pass therethrough while preventing passage of granular salt into the interior volume. In some embodiments, such an interior volume (also referred to herein as a displaced volume) can be defined by the shell itself, by the shell and a surface of a brine tank (e.g., a floor of the brine tank), or some combination thereof. For example, FIGS. 5-7 are related to shell structures where each shell defines an interior volume in conjunction with a respective floor or a brine tank. In another example, FIGS. 8 and 9 are related to shell structures where each shell by itself defines an interior volume. Accordingly, it will be understood that a shell having one or more features as described herein can have an open side when by itself, with the open side being configured to engage with another surface to form an interior volume, or be generally enclosed to define an interior volume by itself.

FIG. 5A shows a perspective view of a shell 100 configured to displace granular salt when placed in a brine tank (e.g., on a floor of the brine tank) to thereby substantially exclude the granular salt in an interior volume defined by the shell 100 and the floor or the brine tank.

In the example of FIG. 5A, the shell 100 has a cone shape having a base 106 and a peak portion 107. In some embodiments, the base 106 can be configured to engage a surface of a brine tank, such as a floor of the brine tank. The peak portion can be implemented as a sharp apex or with a truncated peak as shown. In some embodiments, such a peak portion can include a removable cap 109 that allows relatively easy access to a region within the shell for cleaning, maintenance, etc. In some embodiments, the peak portion 107 can be configured to receive a tube associated with a float assembly.

FIG. 5B shows a side sectional view of the shell 100 of FIG. 5A when the shell 100 is positioned on a surface 110 (e.g., a floor of a brine tank). The base 106 of the shell 100 is shown to engage the surface 110 and thereby have the shell 100 and the surface 110 define an interior volume 112. Accordingly, in relation to the interior volume 112, the region outside of the shell 100 can be referred to as an exterior region 114. It will be understood that in the context of the surface 110 being a floor of a brine tank, such an exterior region will be occupied with granular salt when the brine tank is in operation.

Referring to FIGS. 5A and 5B, one can see that the shell 100 can include a plurality of openings 104 formed on a sloping wall 102 of the cone shape of the shell 100. Such openings can be dimensioned to allow liquid to pass therethrough while preventing passage of granular salt (e.g., from the exterior region 114 into the interior volume 112). Examples of operation of a brine tank utilizing such selective passage functionality are described herein in greater detail.

In some embodiments, design parameters such as opening dimension and number of openings per given area associated with the openings 104 can be selected based on factors such as desired flow rate of the liquid through the shell 100 and a range of sizes of the salt grains. In some embodiments, the openings 114 can be formed during and/or after the formation of the shell 100 utilizing, for example, molding, drilling or heating process.

In some embodiments, a shell having one or more features as described herein, such as the shell 100 of FIGS. 5A and 5B, can be configured to provide an interior volume 112 about an opening of a liquid transfer apparatus (e.g., a tube) to allow transfer of liquid into and away from a corresponding brine tank without any significant amount of granular salt entering the liquid transfer apparatus. Such a liquid transfer apparatus may or may not be routed through the shell 100. For example, a shell without a tube extending therethrough can be utilized in a brine tank where a liquid transfer tubing is routed such that the opening of the liquid transfer tubing is positioned within the interior volume 112.

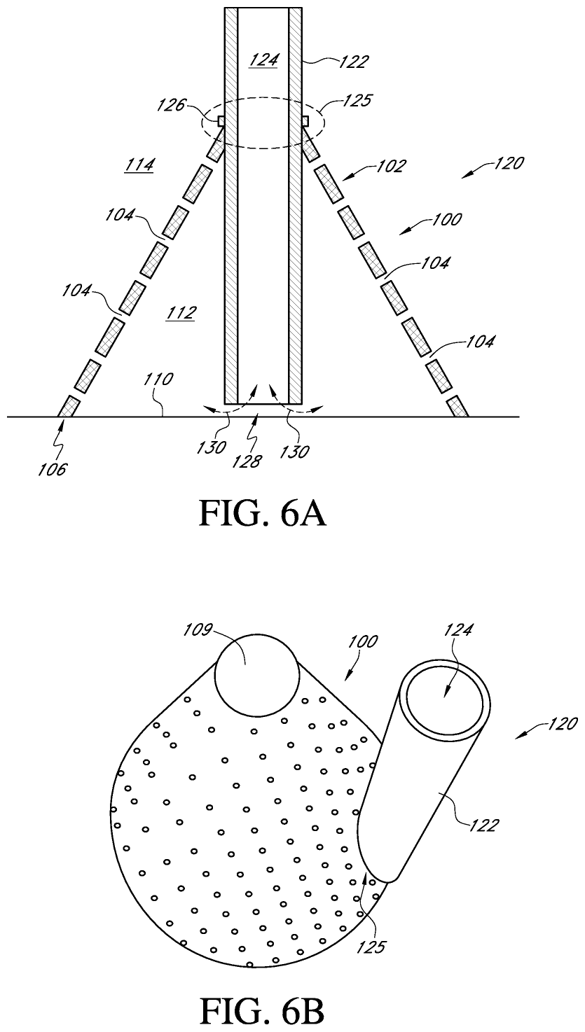

In another example, a liquid transfer tubing may be routed through a shell having one or more features as described herein. FIGS. 6A and 6B show two examples of a shell configured to mate with a tube to provide an interior volume about an opening of the tube, such that the interior volume is substantially free of granular salt when the shell is utilized in a brine tank. More particularly, FIG. 6A shows an example where a shell 100 is configured such that a tube 122 extends through a center portion of the shell 100 at or near its peak portion. FIG. 6B shows an example where a shell 100 is configured such that a tube 122 extends through the shell 100 at a location that is away from the center portion.

Referring to the example of FIG. 6A, the shell 100 is shown to be configured to mate with a tube 122 at or near the peak portion of the shell 100. More particularly, an aperture can be provided at the peak portion of the shell 100 to receive the tube 122 therethrough. The dimension of such an aperture can be selected with respect to the outer dimension of the tube 122 to provide an interface with sufficient sealing to prevent passage of granular salt.

In the example of FIG. 6A, the shell 100 and the tube 122 are shown to form an assembly 120. In some embodiments, the tube 122 can be permanently fixed to the shell 100 (e.g., formed as a single piece or glued together) at an interface 125 to form the assembly 120. In some embodiments, the tube 122 and the shell 100 can be separate pieces that are assembled at an interface 125 to form the assembly 120. In such an embodiment, the interface 125 may or may not include a stop feature 126 configured to allow the tube 122 to be inserted in to the shell 100 by a desirable amount.

In the example of FIG. 6A, the assembly 120 is shown to be positioned on a surface 110 (e.g., floor of a brine tank) such that the base 106 of the shell engages the surface to form an interior volume 112 defined by the shell 100 and the surface 110. An opening of the tube 122 is shown to be positioned close to the surface to form a region 128 for allowing liquid to flow (indicated as arrows 130) into the bottom portion of the brine tank from the inside 124 of the tube 122 or out of the bottom portion of the brine tank in to the inside 124 of the tube 122.

Referring to the example of FIG. 6B, the shell 100 is shown to be configured to mate with a tube 122 at a location away from the center of the shell 100. More particularly, an aperture can be provided on the sloped surface 102 away from the peak portion of the shell 100 to receive the tube 122 therethrough. The dimension of such an aperture can be selected with respect to the outer dimension of the tube 122 to provide an interface with sufficient sealing to prevent passage of granular salt.

In the example of FIG. 6B, the shell 100 and the tube 122 are shown to form an assembly 120. In some embodiments, the tube 122 can be permanently fixed to the shell 100 (e.g., formed as a single piece or glued together) at an interface 125 to form the assembly 120. In some embodiments, the tube 122 and the shell 100 can be separate pieces that are assembled at an interface 125 to form the assembly 120. Configured in the foregoing manner, the assembly 120 of FIG. 6B can operate similar to the assembly 120 of FIG. 6A when positioned in a brine tank.

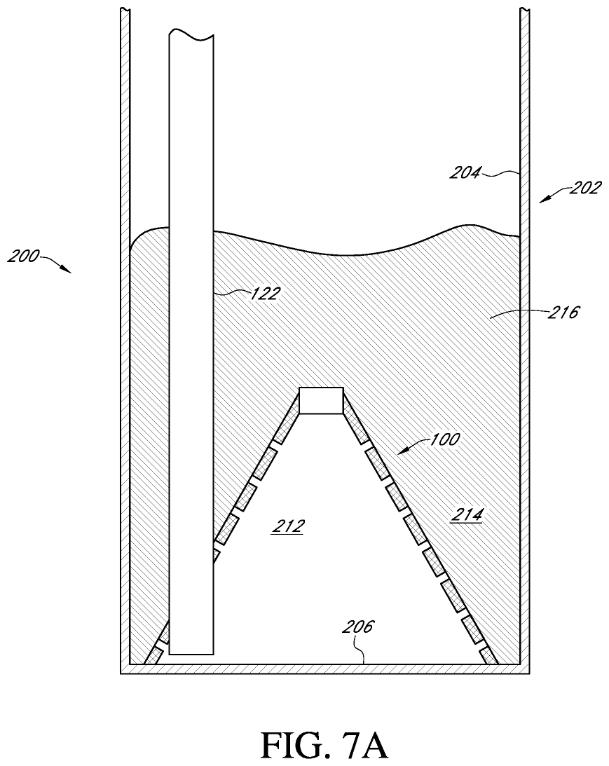

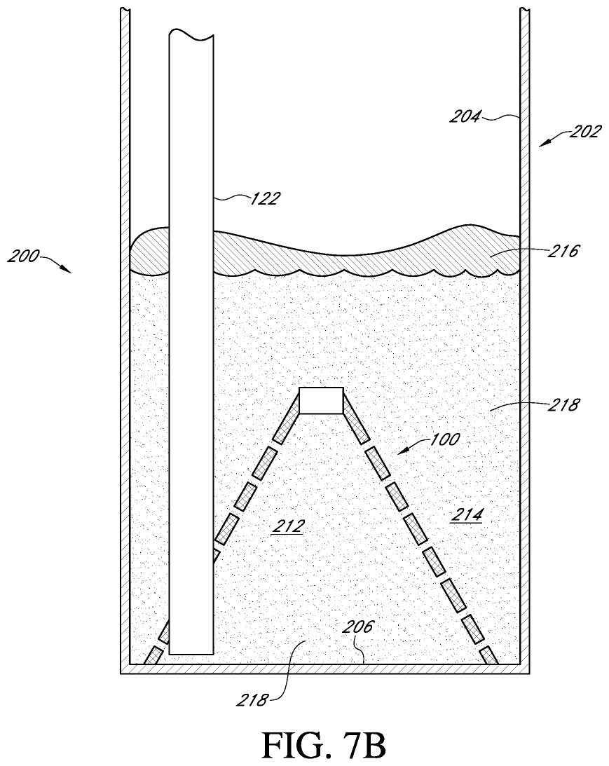

For example, FIGS. 7A and 7B show operation of a brine tank 200 with an assembly of a tube 122 and a shell 100 that is similar to the example assembly 120 of FIG. 6B. In FIGS. 7A and 7B, the brine tank 200 is shown to include a housing 202, and the interior of the housing 202 is shown to include a side wall 204 and a floor 206. The base of the shell 100 is shown to be positioned on the floor 206 of the housing 202, so as to define an interior volume 212 where granular salt 216 is substantially excluded by the shell 100. Accordingly, the granular salt 216 is shown to reside in a region 214 exterior to the interior volume 212.

Referring to FIGS. 7A and 7B, the tube 122 is shown to extend through a sloping wall of the shell 100, and the opening at the end of the tube 122 is shown to be positioned within the interior volume 212 and near the floor 206 of the housing 202. Accordingly, the opening at the end of the tube 122 is substantially free of the granular salt during various operating stages of the brine tank 200.

In the example of FIG. 7A, it is assumed that brine solution is not present in the brine tank 200. In the example of FIG. 7B, liquid has been introduced into the brine tank 200 through the opening at the end of the tube 122. As the level of such liquid rises in the brine tank 200, the liquid is allowed to pass through the openings on the sloped wall of the shell 100, thereby filling the brine tank 200 to a level determined by a float assembly within the tube 122. The liquid then dissolves some of the granular salt to produce a brine solution 218 having an increased concentration of dissolved salt.

As shown in FIG. 7B, the brine solution 218 is present in the interior volume 212 as well as in the exterior region 214, and such a brine solution is able to pass through the openings of the shell 100 between the interior volume 212 and the exterior region 214. Thus, when the brine solution 218 is drawn out of the brine tank 200 through the opening at the end of the tube 122, such drawn brine solution 218 includes the portion from the exterior region 214 while the granular salt remains excluded from the interior volume 212.

As mentioned above, FIGS. 8 and 9 are related to shell structures where each shell by itself defines an interior volume. FIG. 8A shows a perspective view of a shell 100 configured to displace granular salt when placed in a brine tank (e.g., on or above a floor of the brine tank) to thereby substantially exclude the granular salt in an interior volume defined by the shell 100 itself.

In the example of FIG. 8A, the shell 100 has a spherical shape having a curved wall 102 and a base 106. When in use, the base 106 may be positioned to engage a surface of a brine tank (such as a floor of the brine tank) or be positioned above the floor of the brine tank. In some embodiments, a portion of the shell can be utilized for formation of the shell 100. In some embodiments, a portion of the shell 100 can be configured to receive a tube associated with a float assembly.

FIG. 8B shows a side sectional view of the shell 100 of FIG. 8A when the shell 100 is positioned on a surface 110 (e.g., a floor of a brine tank). The base 106 of the shell 100 is shown to rest on the surface 110; however, it will be understood that the shell 100 does not need to engage the surface 110 to define an interior volume 112. In relation to the interior volume 112, the region outside of the shell 100 can be referred to as an exterior region 114. It will be understood that in the context of the surface 110 being a floor of a brine tank, such an exterior region will be occupied with granular salt when the brine tank is in operation.

Referring to FIGS. 8A and 8B, one can see that the shell 100 can include a plurality of openings 104 formed on a curved wall 102 of the spherical shape of the shell 100. Such openings can be dimensioned to allow liquid to pass therethrough while preventing passage of granular salt (e.g., from the exterior region 114 into the interior volume 112).

In some embodiments, a removable cap 109 can be provided at a selected location of the shell 100. Such a removable cap can provide relatively easy access to the interior volume 112 of the shell 100 for cleaning, maintenance, etc.

In some embodiments, design parameters such as opening dimension and number of openings per given area associated with the openings 104 can be selected based on factors such as desired flow rate of the liquid through the shell 100 and a range of sizes of the salt grains. In some embodiments, the openings 114 can be formed during and/or after the formation of the shell 100 utilizing, for example, molding, drilling or heating process.

In some embodiments, a shell having one or more features as described herein, such as the shell 100 of FIGS. 8A and 8B, can be configured to provide an interior volume 112 about an opening of a liquid transfer apparatus (e.g., a tube) to allow transfer of liquid into and away from a corresponding brine tank without any significant amount of granular salt entering the liquid transfer apparatus.

In some embodiments, liquid transfer tube may be routed through a shell having one or more features as described herein. FIGS. 9A and 9B show two examples of a shell configured to mate with a tube to provide an interior volume about an opening of the tube, such that the interior volume is substantially free of granular salt when the shell is utilized in a brine tank. More particularly, FIG. 9A shows an example where a shell 100 is configured such that a tube 122 extends through a center portion of the shell 100. FIG. 9B shows an example where a shell 100 is configured such that a tube 122 extends through the shell 100 at a location that is away from the center portion.

Referring to the example of FIG. 9A, the shell 100 is shown to be configured to mate with a tube 122 at or near the center portion of the shell 100. More particularly, an aperture can be provided at the center portion of the shell 100 to receive the tube 122 therethrough. The dimension of such an aperture can be selected with respect to the outer dimension of the tube 122 to provide an interface with sufficient sealing to prevent passage of granular salt.

In the example of FIG. 9A, the shell 100 and the tube 122 are shown to form an assembly 120. In some embodiments, the tube 122 can be permanently fixed to the shell 100 (e.g., formed as a single piece or glued together) at an interface 125 to form the assembly 120. In some embodiments, the tube 122 and the shell 100 can be separate pieces that are assembled at an interface 125 to form the assembly 120. In such an embodiment, the interface 125 may or may not include a stop feature 126 configured to allow the tube 122 to be inserted in to the shell 100 by a desirable amount.

In the example of FIG. 9A, the assembly 120 is shown to be positioned on a surface 110 (e.g., floor of a brine tank) such that the base 106 of the shell 100 rests on the surface 110 of the brine tank. An opening of the tube 122 is shown to be positioned close to the surface 110 to form a region 128 for allowing liquid to flow (indicated as arrows 130) into the bottom portion of the brine tank from the inside 124 of the tube 122 or out of the bottom portion of the brine tank in to the inside 124 of the tube 122.

Referring to the example of FIG. 9B, the shell 100 is shown to be configured to mate with a tube 122 at a location away from the center of the shell 100. More particularly, an aperture can be provided on the curved wall 102 away from the center portion of the shell 100 to receive the tube 122 therethrough. The dimension of such an aperture can be selected with respect to the outer dimension of the tube 122 to provide an interface with sufficient sealing to prevent passage of granular salt.

In the example of FIG. 9B, the shell 100 and the tube 122 are shown to form an assembly 120. In some embodiments, the tube 122 can be permanently fixed to the shell 100 (e.g., formed as a single piece or glued together) at an interface 125 to form the assembly 120. In some embodiments, the tube 122 and the shell 100 can be separate pieces that are assembled at an interface 125 to form the assembly 120. Configured in the foregoing manner, the assembly 120 of FIG. 9B can operate similar to the assembly 120 of FIG. 9A when positioned in a brine tank.

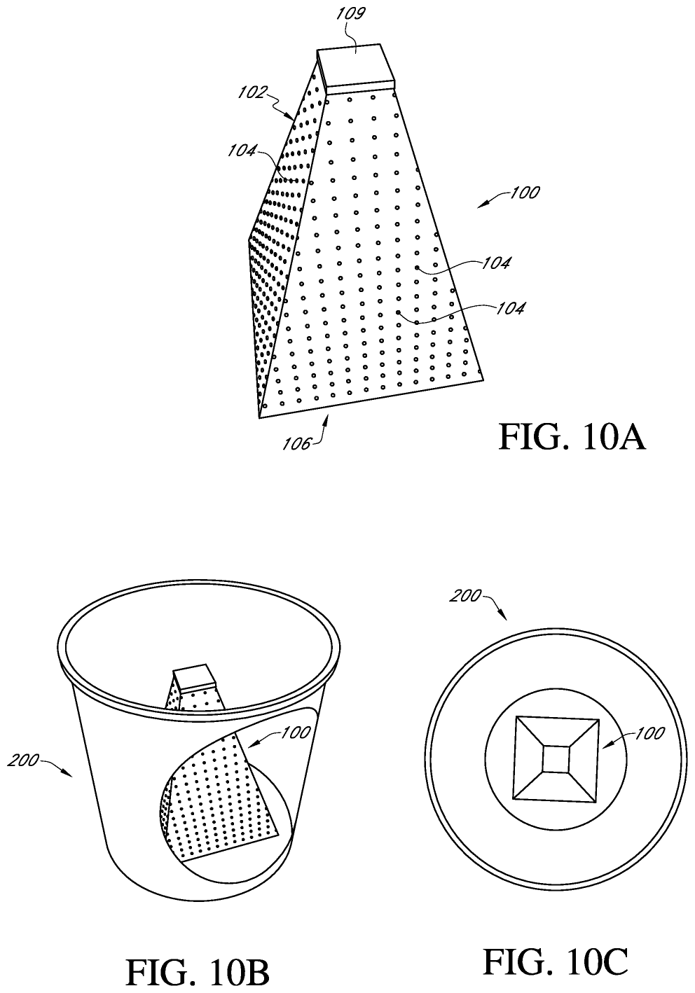

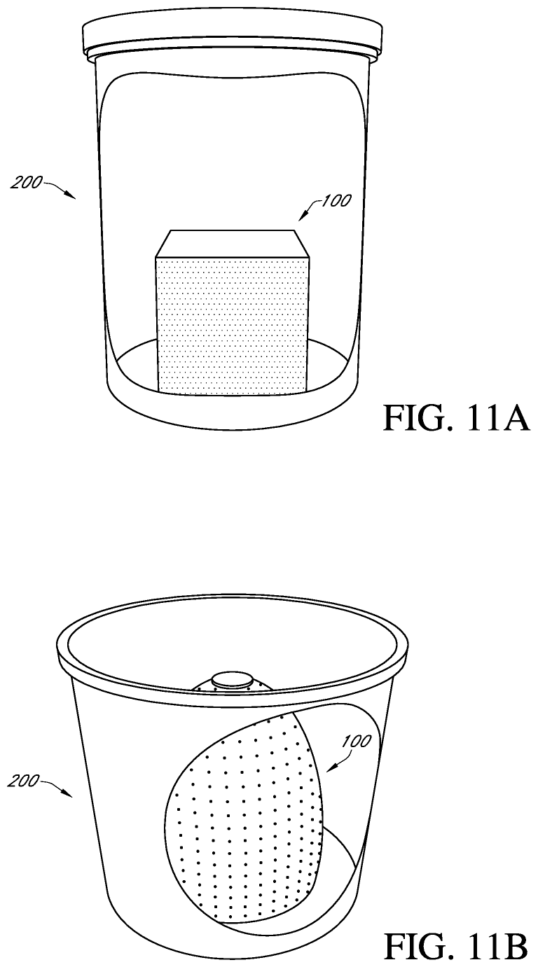

It is noted that the shapes of the shells of FIGS. 5 to 7 (cone shape) and FIGS. 8 and 9 (spherical shape) are simply examples of shapes that may be utilized. Accordingly, it will be understood that a shell having one or more features as described herein can be implemented as other shapes. FIGS. 10 and 11 show non-limiting examples of such other shapes.

For example, FIGS. 10A to 10C show that in some embodiments, a shell 100 having a pyramid shape with a base 106 configured to engage a surface of a brine tank (e.g., a floor of the brine tank) to thereby define an interior volume similar to the interior volume described herein in reference to FIGS. 5A and 5B. the shell 100 is shown to include a plurality of sloping flat walls 102, with the number of such walls being determined by the footprint shape of the base 106. For example, the particular footprint shape of the base 106 in FIG. 10A is a rectangle (e.g., a square); thus, the shell 100 includes four sloping flat walls 102. It will be understood that the pyramid shape of the shell 100 can have other polygonal shaped bases, including a triangle shaped base or a polygonal shaped base having more than four sides.

FIG. 10B shows a perspective and partially cutaway view of a brine tank 200 having the example shell 100 of FIG. 10A positioned therein. FIG. 10C shows the same brine tank 200 and the pyramid shaped shell 100 in a plan view. It will be understood that the shell 100 of FIGS. 10A to 10C can be configured with a plurality of openings 104, mated with a tube (122 in FIGS. 6 and 7) and be utilized with the brine tank 200 similar to the examples of FIGS. 6 and 7.

FIGS. 11A and 11B show additional examples of shells having one or more features as described herein. FIG. 11A shows that in some embodiments, a shell 100 can have a rectangular cuboid shape such as a cube shape where each of the six sides has a square shape. In some embodiments, one rectangular shaped side (e.g., one square shaped side) can be open and be configured as a base, such that the other five rectangular shaped sides (e.g., square shaped sides) and a surface (e.g., floor of a brine tank) on which the shell 100 is positioned define an interior volume, similar to the interior volumes associated with the shells of FIGS. 7 and 10. In some embodiments, the shell 100 of FIG. 11A can have all of the six rectangular shaped sides (e.g., square shaped sided) to define an interior volume by itself whether or not the shell 100 is positioned on a surface, similar to the interior volumes associated with the shells of FIGS. 8 and 9.

In the example of FIG. 11A, some or all of the sides of the shell 100 can include a plurality of openings (to allow passage of liquid but not granular salt), mated with a tube and be utilized with a brine tank 200 similar to the examples of FIGS. 6 and 7.

It is noted that in the example of FIG. 11A, one side of the rectangular cuboid shape engages the floor of the brine tank 200, four sides form walls that are approximately vertical with respect to the floor, and the sixth side forms a ceiling that is approximately parallel with the floor. Thus, each of the four side walls can be considered to have an infinite or large slope relative to the floor of the brine tank 200. It is also noted that in the example of FIGS. 10A to 10C, the pyramid shaped shell 100 includes a plurality of sloping flat walls 102 where each sloping flat wall has a slope angle (relative to the floor of the brine tank 200) that is greater than zero and less than the infinite or large slope value associated with the example shell 100 of FIG. 11A. Accordingly, a shell having one or more features as described herein, including a plurality of flat wall sides, can be dimensioned such that each flat wall side has a slope angle that is greater than zero relative to a surface on which the shell is positioned.

FIG. 11B shows that in some embodiments, a shell 100 can have a curved shape such as a truncated ellipsoid shape. In some embodiments, an elliptical shape (e.g., circular shape) resulting from the truncation can be open and be configured as a base, such that the remaining portion of the ellipsoid shape and a surface (e.g., floor of a brine tank) on which the shell 100 is positioned define an interior volume, similar to the interior volumes associated with the shells of FIGS. 7 and 10. In some embodiments, the shell 100 of FIG. 11B can have the elliptical shape (e.g., circular shape) resulting from the truncation be provided with its own floor to define an interior volume by itself whether or not the shell 100 is positioned on the floor of a brine tank, similar to the interior volumes associated with the shells of FIGS. 8 and 9.

In the example of FIG. 11B, some or all of the surfaces of the shell 100 can include a plurality of openings (to allow passage of liquid but not granular salt), mated with a tube and be utilized with a brine tank 200 similar to the examples of FIGS. 6 and 7.

In various examples described herein, a given brine tank is depicted as having one shell provide an interior volume where granular salt is excluded from an opening of a tube. For example, FIGS. 7, 10 and 11 are related to brine tanks each having a respective single shell. It will be understood that in some embodiments, a brine tank can include more than one shell each having one or more features as described herein.

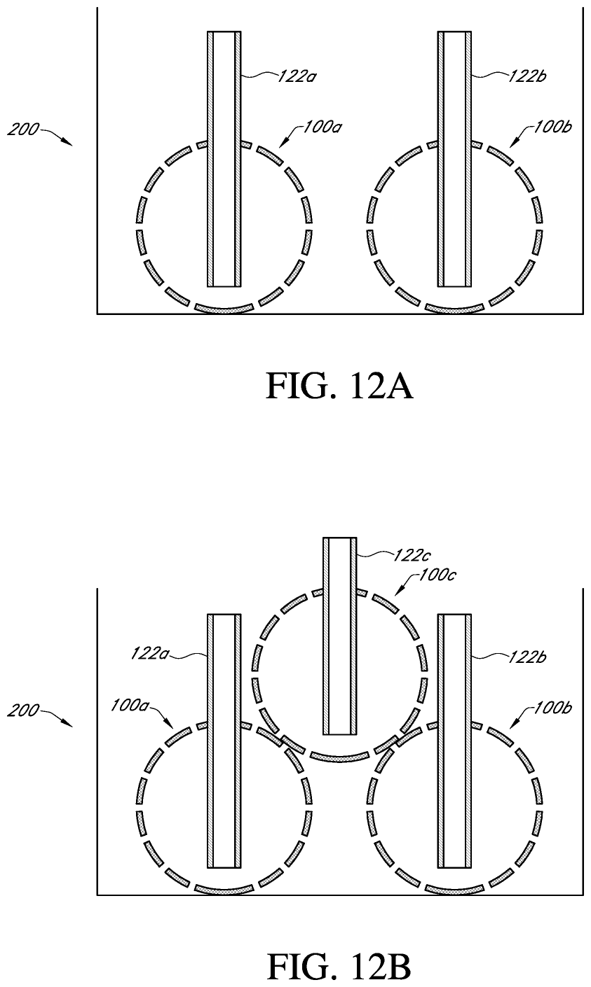

For example, FIG. 12A shows an assembly where a plurality of shells 100a, 100b are implemented inside a brine tank 200. In the example of FIG. 12A, each shell is depicted as being a spherical shaped shell similar to the example of FIG. 9A. More particularly, a respective tube (122a or 122b) is shown to mate with each shell (100a or 100b) at a center portion of the shell. Thus, the tube 122a is shown to have its inlet/outlet opening within an interior volume provided by the shell 100a; and the tube 122b is shown to have its inlet/outlet opening within an interior volume provided by the shell 100b. It will be understood that the tubes 122a, 122b can be configured to transfer liquid to and from the brine tank 200 independently, through a common tube (not shown) in communication with each of the tubes 122a, 122b, or some combination thereof.

In the example of FIG. 12A, each shell is depicted as providing a respective interior volume by itself. It will be understood that in some embodiments, a similar configuration (where a plurality of shells are provided for a given brine tank) can be implemented where each of a plurality of shells provides an interior volume in conjunction with a surface (e.g., floor surface) of the brine tank (e.g., as in FIGS. 6 and 7).

It will be understood that in some embodiments, a plurality of shells can be provided for a given brine tank, and at least some of such shells can be configured such that each provides an interior volume by itself (e.g., as in FIG. 9), and at least some of such shells can be configured such that each provides an interior volume in conjunction with a surface (e.g., floor surface) of the brine tank (e.g., as in FIGS. 6 and 7).

In the example of FIG. 12A, a plurality of shells are arranged so that all of the shells engage a common surface (e.g., floor of the brine tank). FIG. 12B shows that in some embodiments, a plurality of shells 100a, 100b, 100c can be positioned at a plurality of different levels inside a brine tank 200. In the example of FIG. 12B, two shells 100a, 100b are depicted as being positioned to engage the floor surface of the brine tank 200, and the third shell 100c is shown to be positioned above the two shells 100a, 100b. In the example of FIG. 12B, a respective tube (122a, 122b or 122c) is shown to mate with each shell (100a, 100b or 100c) at a center portion of the shell. It will be understood that the tubes 122a, 122b, 122c can be configured to transfer liquid to and from the brine tank 200 independently, through a common tube (not shown) in communication with each of the tubes 122a, 122b, 122c, or some combination thereof.

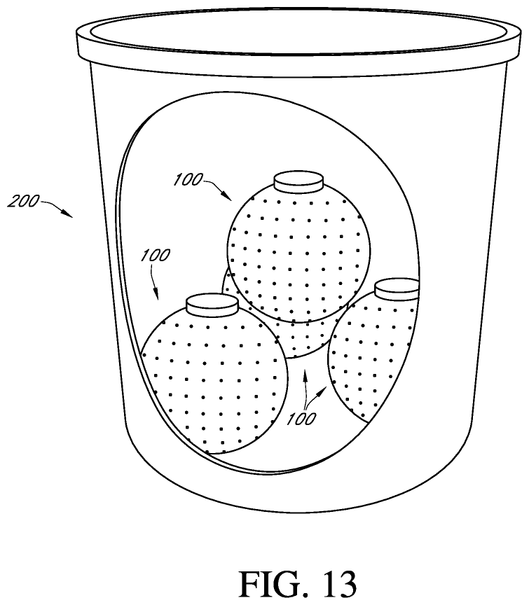

FIG. 13 shows an assembly of a plurality of shells 100 implemented within a brine tank 200 similar to the example of FIG. 12B. In the example of FIG. 13, the shells 100 are shown to be arranged in an approximate cubic close packing configuration, but with the three base group of shells being separated from each other to allow flow of liquid therebetween. In the example of FIG. 13, each of the shells 100 can be mated to a respective tube similar to the example of FIG. 12B.

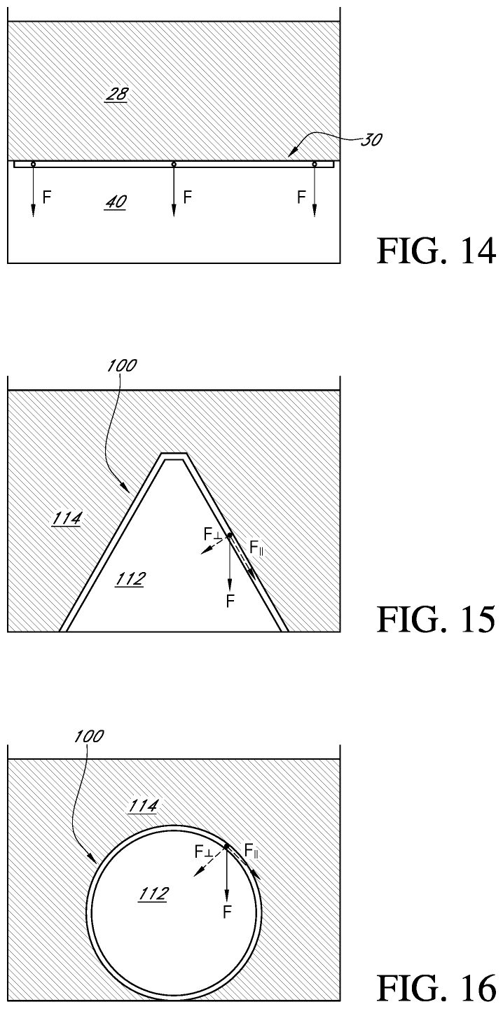

A shell having one or more features as described herein can provide a number of desirable functionalities when utilized in a brine tank, when compared to a conventional grid plate. For example, FIG. 14 shows a conventional grid plate 30 positioned inside a brine tank so as to provide a substantially granular salt free region 40 and a region 28 occupied by granular salt. As described herein, the generally flat grid plate 30 needs to be dimensioned to fit relatively tightly with respect to the inner dimension of the brine tank to prevent passage of granular salt along its edge portion. Accordingly, essentially any location on the grid plate 30 is subjected to a net downward force F resulting from the weight of the granular salt in the region 28. Due to such downward forces on the grid plate 30, a robust (and often complex) support structure (e.g., 32 in FIGS. 1 to 4) needs to be provided underneath the grid plate 30.

In contrast, and referring to FIGS. 15 and 16, a shell having one or more features as described herein can provide a substantially granular salt free region 112 (also referred to herein as an interior volume) and a region 114 occupied by granular salt (also referred to herein as an exterior region) with a greater flexibility in implementation in a brine tank and without requiring use of a separate support structure. As described herein, a shell can be dimensioned relative to an internal dimension of the brine tank to allow the shell to be positioned in and removed from the brine tank in a much easier manner (e.g., by having the overall lateral dimension of the shell be significantly less than the lateral dimension of the internal dimension of the brine tank).

Referring to FIGS. 15 and 16, a shell 100 having one or more features as described herein can be configured to provide structural integrity by virtue of its same, even when subjected to the weight of granular salt occupying the exterior region 114. For example, and referring to FIG. 15 that shows an example of a shell having an open side (e.g., such as the cone shaped example of FIGS. 5 to 7 and the pyramid shaped example of FIG. 10) positioned on a floor of a brine tank so as to define the interior volume 112 that is substantially free of granular salt that is displaced and kept in the exterior region 114. At a given location on the sloping wall of the shell 100, weight of the granular salt results in a downward force F; however, such a downward force can be expressed as a vector sum of a component parallel with the sloping wall (indicated as F_{∥}) and a component perpendicular to the sloping wall (indicated as F_{⊥}). Accordingly, and depending on the angle the sloping wall forms with the floor of the brine tank, the perpendicular force (F_{⊥}) on the sloping wall is significantly less than the downward force (F) resulting from the granular salt, due to the sloping wall bearing a significant amount of the downward force (F) (in the form of the parallel force (F_{∥})). Accordingly, the shell structure itself is shown to provide structural strength when subjected to a volume of granular salt above and around the shell 100.

It is noted that such a feature of structural integrity by virtue of the shell structure also applies to other example shapes described herein, including the cube shaped shell of FIG. 11A and the truncated ellipsoid shaped shell of FIG. 11B.

It is also noted that a feature of structural integrity by virtue of the shape of a shell structure also applies to a shell that defines an interior volume by itself. For example, FIG. 16 shows a shell 100 having a spherical shape similar to the examples of FIGS. 8, 9, 12 and 13, where the shell defines an interior volume 112 that is substantially free of granular salt that is displaced and kept in the exterior region 114. At a given location on the curved wall of the shell 100, weight of the granular salt results in a downward force F; however, such a downward force can be expressed as a vector sum of a component tangentially parallel with the curved wall (indicated as F_{∥}) and a component perpendicular to the curved wall (indicated as F_{⊥}). Accordingly, and depending on the location of the curved wall, the perpendicular force (F_{⊥}) on the curved wall is significantly less than the downward force (F) resulting from the granular salt, due to the curved wall bearing a significant amount of the downward force (F) (in the form of the parallel force (F_{∥})). Accordingly, the shell structure itself is shown to provide structural strength when subjected to a volume of granular salt above and around the shell 100.

In some embodiments, a shell having one or more features as described herein can be implemented with material suitable for use in a brine tank environment. For example, material of the shell can be sufficiently dense to allow the shell to sink in a brine solution, such that the shell can remain in its position (e.g., on the floor of the brine tank) even in the absence of granular salt providing a downward force.

In another example, material of the shell can be such that the shell is less dense than a brine solution. In such an example, the shell can be made to remain in its operating position (e.g., on the floor of the brine tank) with the weight of granular salt.

In yet another example, the shell can be formed from a first material that is less dense that a brine solution, but be weighed with a second material having greater density, such that the net density of the shell is greater than the density of the first material. Such a net density of the shell may or may not be greater than the density of the brine solution.

In some embodiments, a shell having one or more features as described herein can be formed from one or more materials including, for example, different forms of plastic, metal, alloy, etc.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A device for use in a brine tank, the device comprising a shell that defines an interior volume and configured to displace granular salt from the interior volume when the granular salt is present in the brine tank, the shell further configured to allow liquid to pass therethrough while preventing the granular salt from entering the interior volume.

2. The device of claim 1, wherein the shell is configured to mate with a tube such that when the tube is mated with the shell for operation including transfer of the liquid to and from the brine tank through an opening of the tube, the opening of the tube is positioned within the interior volume.

3. The device of claim 1, wherein the shell has a shape that includes a wall, at least a portion of the wall having a vertical component when the shell is positioned on a floor of the brine tank, the floor of the brine tank defining a horizontal plane and the vertical component being in a direction perpendicular to the horizontal plane, such that the interior volume of the shell is defined by at least the wall.

4. The device of claim 3, wherein the interior volume of the shell is defined by the wall itself.

5. The device of claim 4, wherein the wall includes a curvature such that the shell is a three-dimensional shell having a curved wall in a side sectional view.

6. (canceled)

7. (canceled)

8. (canceled)

9. (canceled)

10. The device of claim 4, wherein the wall includes a straight portion such that the shell is a three-dimensional shell having a straight wall in a side sectional view.

11. (canceled)

12. (canceled)

13. (canceled)

14. (canceled)

15. The device of claim 3, wherein the interior volume of the shell is defined by the wall and the floor of the brine tank.

16. The device of claim 15, wherein the shell is a three-dimensional shell having an open base configured to engage the floor of the brine tank to define the interior volume of the shell.

17. The device of claim 16, wherein the wall includes a curvature such that the three-dimensional shell has a curved wall in a side sectional view.

18. (canceled)

19. (canceled)

20. The device of claim 16, wherein the wall includes a straight portion such that the shell is a three-dimensional shell having a straight wall in a side sectional view.

21. (canceled)

22. (canceled)

23. (canceled)

24. (canceled)

25. The device of claim 3, wherein the at least a portion of the wall includes a plurality of openings each dimensioned to allow flow of the liquid therethrough while preventing the granular salt from entering the interior volume.

26. The device of claim 25, wherein each opening of the wall is dimensioned to prevent passage of a salt particle having an average dimension greater than or equal to the dimension of the opening.

27. The device of claim 25, wherein the dimension of the opening is selected so that a partially dissolved salt particle or an undissolved salt particle having an average dimension that enters the interior volume of the shell is sufficiently small such that the salt particle either dissolves in the liquid or does not cause an undesirable effect when the liquid is transferred from the brine tank.

28. The device of claim 3, wherein the shell is formed as a single piece.

29. The device of claim 3, wherein the shell is formed as an assembly of a plurality of pieces.

30. The device of claim 3, wherein the shell is formed from one or more materials having resilience in a condition exposed to the granular salt and the liquid having dissolved salt.

31. (canceled)

32. The device of claim 3, wherein the shell further includes a removable cap configured to allow the shell to maintain the interior volume substantially free of the granular salt when installed on the shell, and to allow access to the interior volume of the shell when removed from the shell.

33. An assembly for use in a brine tank, comprising:
a tube including an opening and configured to allow transfer of liquid to and from the brine tank through the opening; and
a shell configured to be positioned within the brine tank and define an interior volume around the opening of the tube, the shell further configured to displace granular salt from the interior volume when the granular salt is present in the brine tank, the shell further configured to allow the liquid to pass therethrough while preventing the granular salt from entering the interior volume.

34. The assembly of claim 33, wherein the shell is mated with the tube such that during transfer of the liquid to and from the brine tank through the opening of the tube, the opening of the tube is positioned within the interior volume.

35. A brine tank system comprising:
a brine tank configured to store granular salt;
an opening configured to allow transfer of liquid to and from the brine tank; and
a shell that defines an interior volume around the opening, the shell further configured to displace granular salt from the interior volume when the granular salt is present in the brine tank, the shell further configured to allow the liquid to pass therethrough while preventing the granular salt from entering the interior volume.

36. (canceled)

37. (canceled)

38. (canceled)

39. (canceled)

40. (canceled)
